(19) United States
(12) Patent Application Publication
(10) Pub. No.: US 2025/0028235 A1
(43) Pub. Date: Jan. 23, 2025

(54) OPTICAL PROXIMITY CORRECTION METHODS AND MASK MANUFACTURING METHODS INCLUDING THE OPTICAL PROXIMITY CORRECTION METHODS

(71) Applicant: SAMSUNG ELECTRONICS CO., LTD., Suwon-si (KR)

(72) Inventors: Heungsuk OH, Suwon-si (KR); Hun KANG, Suwon-si (KR); Sangwook KIM, Suwon-si (KR); Sanghun KIM, Suwon-si (KR); Sujin OH, Suwon-si (KR); Jinseok OH, Suwon-si (KR)

(21) Appl. No.: 18/643,392

(22) Filed: Apr. 23, 2024

(30) Foreign Application Priority Data
Jul. 18, 2023 (KR) 10-2023-0093342

(51) Int. Cl. G03F 1/36; G03F 1/70; G06F 30/392; G06F 119/18

(52) U.S. Cl. CPC G03F 1/36; G03F 1/70; G06F 30/392; G06F 2119/18

(57) ABSTRACT

Provided are an optical proximity correction (OPC) method capable of maintaining full-chip bias consistency and a mask manufacturing method including the OPC method. The OPC method includes obtaining a first optical proximity corrected (OPCed) design layout by implementing a first OPC on an OPC target design layout; performing a reverse dissection on the OPC target design layout based on the first OPCed design layout to generate first segments; performing a reverse correction to allocate first biases of the first OPCed design layout to the first segments of the OPC target design layout; determining a full-chip representative bias based on a segment grouping of the first segments; applying the full-chip representative bias to an entire chip area; preparing mask data based on the full-chip representative bias that has been applied to the entire chip area; and exposing a mask substrate based on the mask data.

### CROSS-REFERENCE TO RELATED APPLICATION

This application is based on and claims priority under 35 U.S.C. § 119 to Korean Patent Application No. 10-2023-0093342, filed on Jul. 18, 2023, in the Korean Intellectual Property Office, the disclosure of which is incorporated by reference herein in its entirety.

### BACKGROUND

The present disclosures and the inventive concepts thereof relate to mask manufacturing methods, and more particularly to, optical proximity correction (OPC) methods and mask manufacturing methods using the OPC methods.

In a semiconductor process, a photolithography process using a mask may be performed to form a pattern on a semiconductor substrate such as a wafer. The mask may be referred to as a pattern-transferred body having an opaque-material pattern shape formed on a transparent base layer material. Such a mask may be manufactured by designing a required circuit, designing a layout of the circuit, and transferring design data obtained by optical proximity correction (OPC) as mask tape-out (MTO) design data. Thereafter, mask data preparation (MDP) may be performed based on the MTO design data, and an exposure process or the like may be performed on a mask substrate.

### SUMMARY

The present disclosures and the inventive concepts thereof provide optical proximity correction (OPC) methods improving (e.g., capable of maintaining) full-chip bias consistency, and mask manufacturing methods including the OPC methods.

The present disclosures and the inventive concepts thereof are not limited to those mentioned above and will be apparently understood by those skilled in the art through the following description.

According to an aspect of the inventive concept, there is provided a mask manufacturing method including obtaining a first optical proximity corrected (OPCed) design layout by implementing a first optical proximity correction (OPC) on an OPC target design layout; performing a reverse dissection on the OPC target design layout based on the first OPCed design layout to generate first segments; performing a reverse correction to allocate first biases of the first OPCed design layout to the first segments of the OPC target design layout; determining a full-chip representative bias based on a segment grouping of the first segments; applying the full-chip representative bias to an entire chip area; preparing mask data based on the full-chip representative bias that has been applied to the entire chip area; and exposing a mask substrate based on the mask data.

According to another aspect of the inventive concept, there is provided a mask manufacturing method including obtaining a first optical proximity corrected (OPCed) design layout by implementing a first optical proximity correction (OPC) on an OPC target design layout; performing a reverse dissection on the OPC target design layout based on the first OPCed design layout to generate first segments; performing a reverse correction to allocate first biases of the first OPCed design layout to the first segments of the OPC target design layout; performing a segment grouping by grouping the first segments that have identical surroundings into first groups; determining a patch representative bias for the first groups of each patch; determining a full-chip representative bias for the first groups in an entire chip area; applying the full-chip representative bias to the entire chip area to generate a finally OPCed design layout; preparing mask data based on the finally OPCed design layout; and exposing a mask substrate based on the mask data.

According to another aspect of the inventive concept, there is provided a mask manufacturing method including obtaining a first optical proximity corrected (OPCed) design layout by implementing a first optical proximity correction (OPC) on an OPC target design layout; performing a reverse dissection on the OPC target design layout based on the first OPCed design layout to generate first segments; performing a reverse correction to allocate first biases of the first OPCed design layout to the first segments of the OPC target design layout; determining a full-chip representative bias based on a segment grouping of the first segments; applying the full-chip representative bias to an entire chip area to obtain a finally OPCed design layout; preparing data on the finally OPCed design layout as mask tape-out (MTO) design data; preparing mask data based on the MTO design data; and exposing a mask substrate based on the mask data.

### BRIEF DESCRIPTION OF THE DRAWINGS

Embodiments will be more clearly understood from the following detailed description taken in conjunction with the accompanying drawings in which:

FIG. 1 is a flowchart schematically illustrating operations of an optical proximity correction (OPC) method according to some embodiments;

FIGS. 2A, 2B, and 2C are conceptual views illustrating an operation of obtaining a first optical proximity corrected (OPCed) design layout in the OPC method shown in FIG. 1;

FIGS. 3A, 3B, and 3C are conceptual views illustrating the concept of bias consistency in a full chip;

FIGS. 4A and 4B are conceptual views illustrating an operation of performing a reverse dissection in the OPC method shown in FIG. 1;

FIGS. 5A and 5B are conceptual views illustrating an unusual case in an operation of generating dissection points as shown in FIG. 4B;

FIGS. 6A, 6B, 6C, 6D, and 6E are conceptual views illustrating an operation of performing a reverse correction in the OPC method shown in FIG. 1;

FIG. 7 is a conceptual view illustrating an internalized OPC target design layout generated after performing the reverse correction in the OPC method shown in FIG. 1;

FIGS. 8A, 8B, and 8C are a flowchart and conceptual views illustrating operations of calculating a full-chip representative bias in the OPC method shown in FIG. 1;

FIGS. 9A and 9B are conceptual views illustrating an operation of applying the full-chip representative bias to an entire chip area in the OPC method shown in FIG. 1;

FIGS. 10A and 10B are conceptual views illustrating results of actual application of the OPC method shown in FIG. 1; and

FIG. 11 is a flowchart schematically illustrating operations of a mask manufacturing method including an OPC method according to some embodiments.

### DETAILED DESCRIPTION

Hereinafter, embodiments will be described with reference to the accompanying drawings. In the drawings, like reference numerals may denote like elements unless clearly stated otherwise, and repeated descriptions thereof may be omitted.

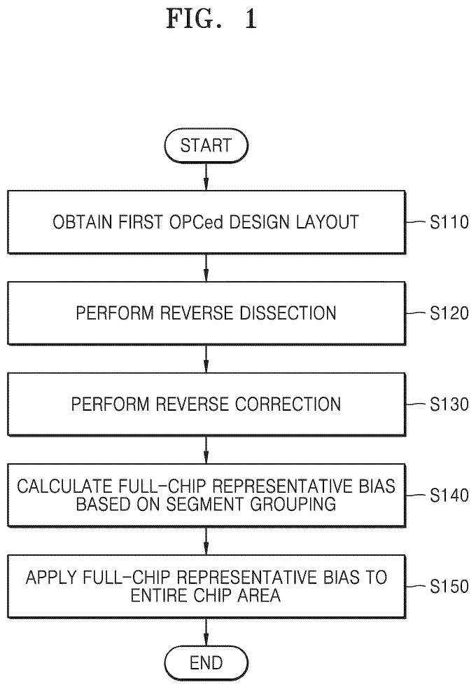

FIG. 1 is a flowchart schematically illustrating operations of an optical proximity correction (OPC) method according to some embodiments.

Referring to FIG. 1, according to some embodiments, in the OPC method, a first optical proximity corrected (OPCed) design layout may be obtained by applying a first OPC to an OPC target design layout (operation S110). The OPC target design layout may refer to a design layout of a target pattern to be formed on a substrate such as a wafer. The target pattern may be formed on the substrate by transferring a pattern of a mask (mask pattern) onto the substrate through an exposure process. Therefore, the OPC target design layout may refer to a layout of the mask pattern corresponding to the target pattern to be formed on the substrate. In addition, because the mask pattern may be scaled down and projected onto the substrate (wafer), the mask pattern may have a larger size than the target pattern on the substrate.

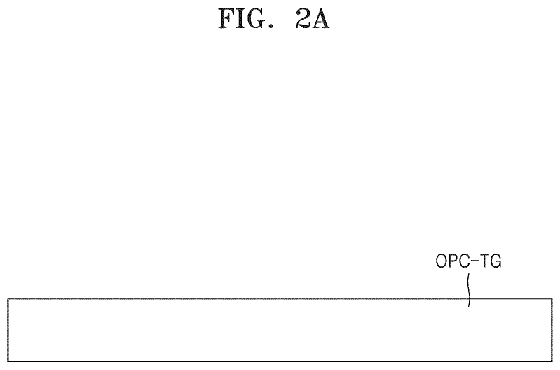

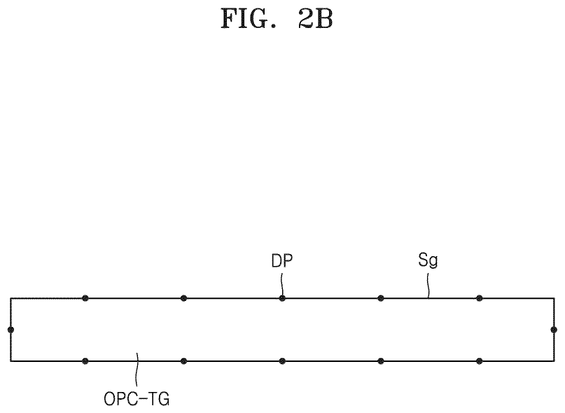

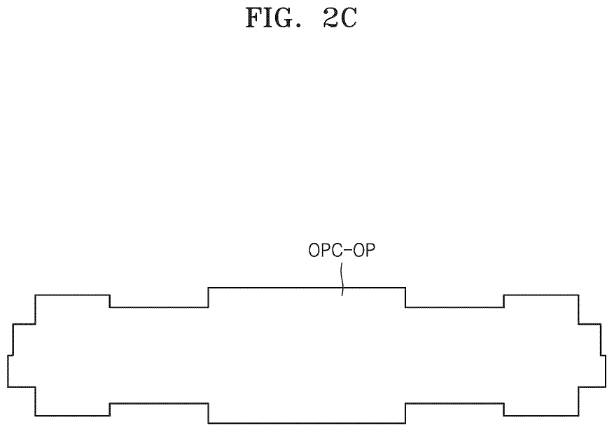

In addition, the first OPC may refer to a basic OPC or a commercial OPC that is commonly used in mask manufacturing methods. Furthermore, according to some embodiments, in the OPC method, a second OPC may refer to a concept including all operations performed on the first OPCed design layout for bias consistency (to be described later). Therefore, the second OPC may be performed on the first OPCed design layout to obtain a second OPCed design layout. Operation S110 of obtaining a first OPCed design layout is further described with reference to FIGS. 2A, 2B, and 2C.

Thereafter, a reverse dissection may be performed on the OPC target design layout (e.g., an internal OPC target design layout iOPC-TG, which will be described below) based on the first OPCed design layout (operation S120). Operation S120 of performing the reverse dissection and subsequent operations may be for allocating the same bias to segments having the same surroundings. In principle (or in theory), within a first OPCed design layout for a full chip, segments, which will be further described below, having the same surroundings have the same bias. However, in a first OPCed design layout for a full chip, segments having the same surroundings may have different biases, and in this case, mask quality errors may occur. This situation in which segments having the same surroundings have different biases may be called a full-chip bias consistency issue or a full-chip consistency issue. The term “bias” may be simply defined as a difference or distance between a segment of an OPC target design layout and a corresponding segment of a first OPCed design layout (generated by the first OPC based on the OPC target design layout, for example, an internal OPC target design layout iOPC-TG, which will be described below).

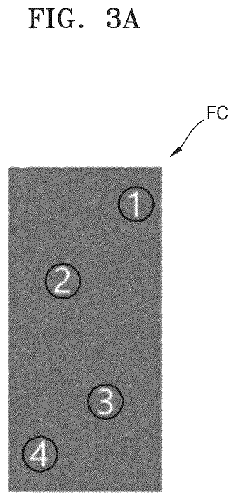

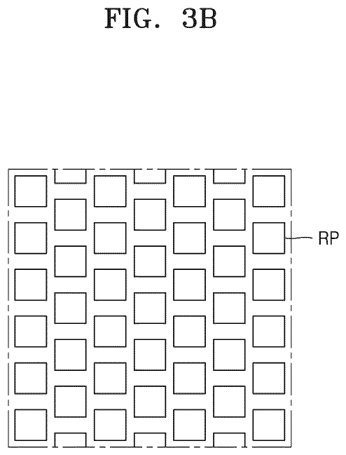

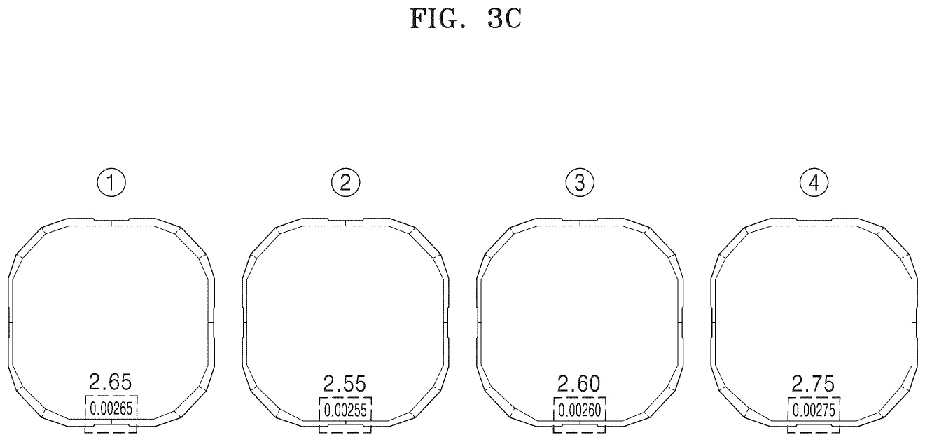

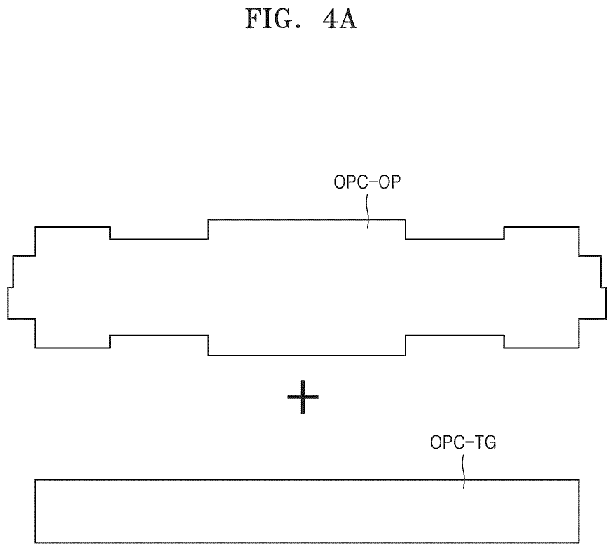

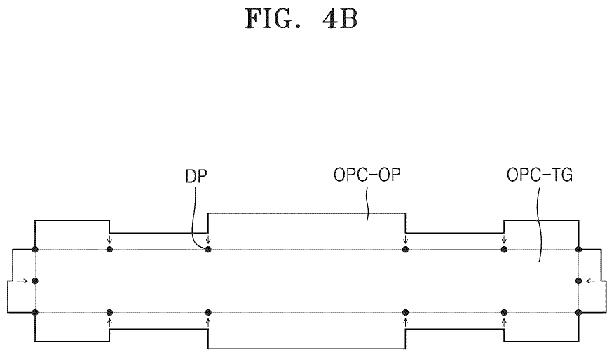

The full-chip consistency issue is described with reference to FIGS. 3A, 3B, and 3C. In addition, operation S120 of performing a reverse dissection is further described with reference to FIGS. 4A and 4B.

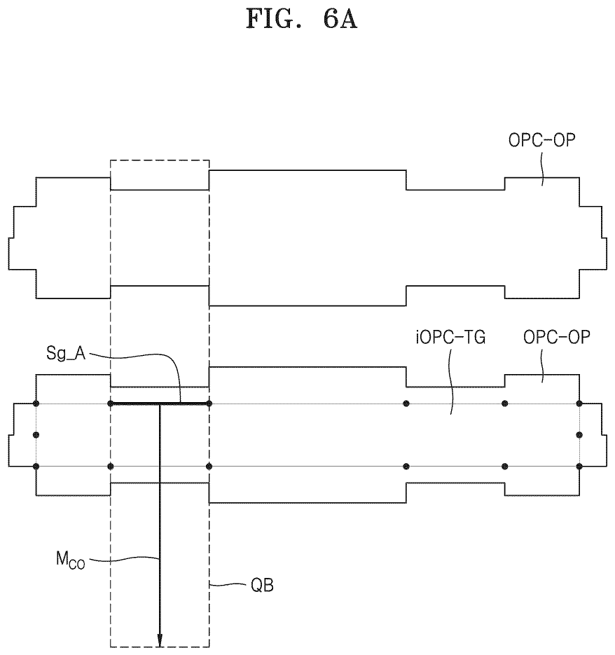

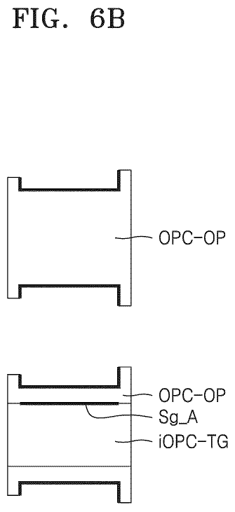

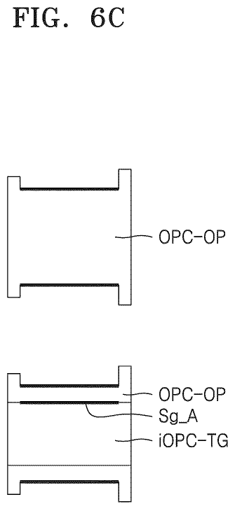

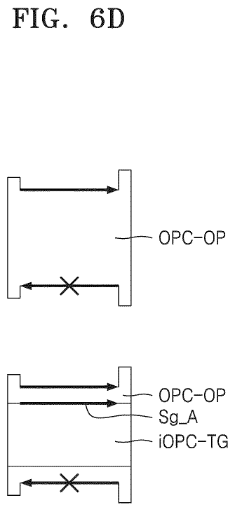

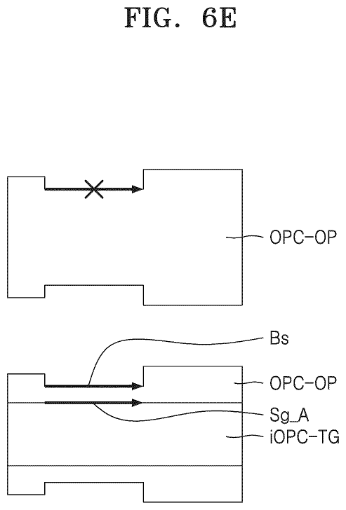

After performing the reverse dissection, a reverse correction may be performed to allocate biases to segments generated by the reverse dissection (operation S130). The reverse correction may be an operation of calculating a bias for each segment generated by the reverse dissection. Reverse correction is further described with reference to FIGS. 6A, 6B, 6C, 6D, and 6E. Herein, calculating may refer to determining or generating. For example, calculating A based on B may refer to determining A based on B or generating A based on B.

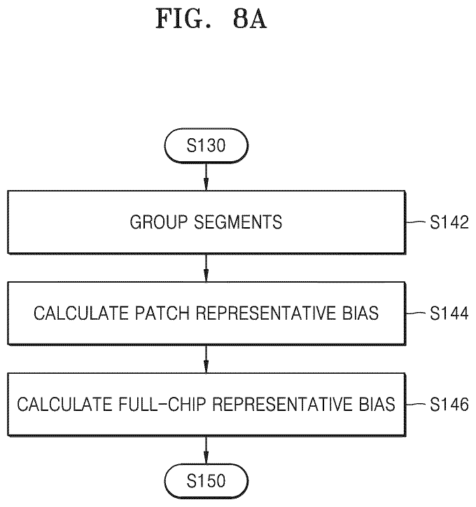

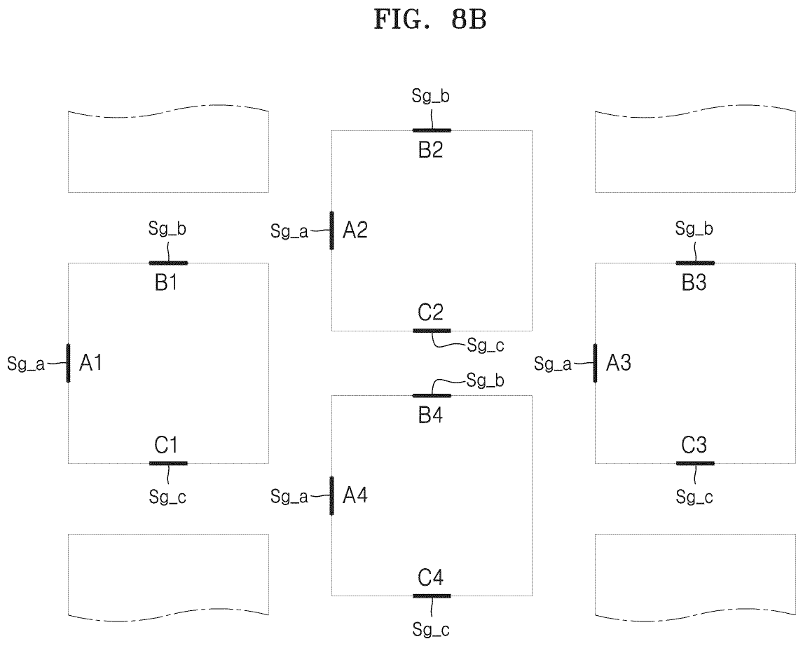

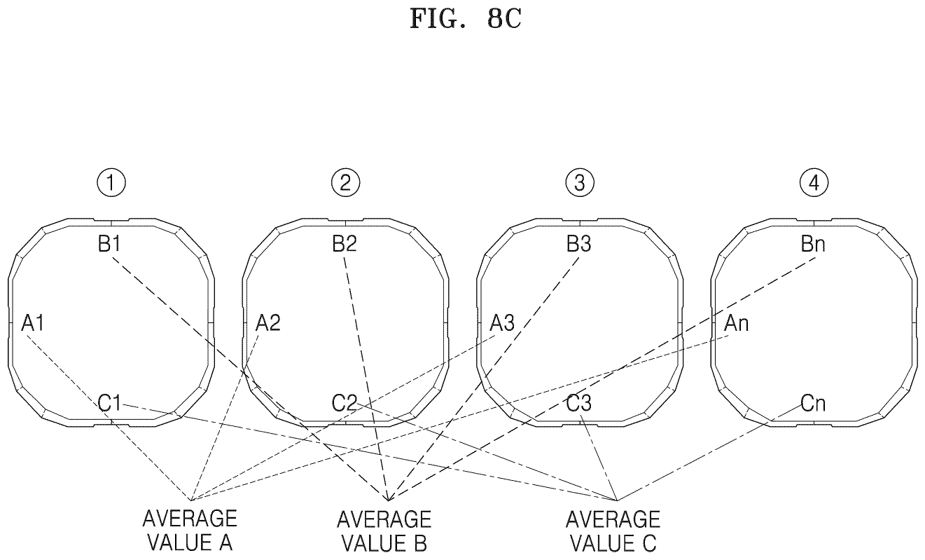

After performing the reverse correction, a full-chip representative bias may be calculated based on a segment grouping (operation S140). The segment grouping may refer to an operation of grouping segments having the same surroundings. In addition, the calculation of a full-chip representative bias may be performed by calculating a representative bias (a patch representative bias) for each patch, and then calculating a representative bias (the full-chip representative bias) for all patches. For reference, in an operation such as an operation of calculating biases for segments, a full chip may be divided into a plurality of patches in a checkered pattern form. The calculation of a full-chip representative bias is further described with reference to FIGS. 8A, 8B, and 8C.

After calculating the full-chip representative bias, the full-chip representative bias may be applied to an entire chip area (operation S150). The second OPCed design layout may be obtained by applying the full-chip representative bias to the entire chip area. As described above, operations additionally performed on the first OPCed design layout for bias consistency may correspond to the second OPC. For example, the second OPC, that is, operations for bias consistency, may include operation S120 of performing a reverse dissection, operation S130 of performing a reverse correction, operation S140 of calculating a full-chip representative bias, and operation S150 of applying the full-chip representative bias to an entire chip area.

According to some embodiments, in the OPC method, the second OPCed design layout may correspond to a finally OPCed design layout. In addition, according to some embodiments, the OPC method may perform the second OPC on the first OPCed design layout obtained through the first OPC (basic OPC or commercial OPC) to obtain the second OPCed design layout, and the second OPCed design layout may address the full-chip consistency issue. In other words, the second OPCed design layout may improve (e.g., maintain) full-chip consistency such that all segments having the same surroundings in the entire chip area may have the same bias value.

FIGS. 2A, 2B, and 2C are conceptual views illustrating operation S110 of obtaining a first OPCed design layout in the OPC method shown in FIG. 1. Descriptions given with reference to FIG. 1 may be briefly given here or omitted.

Referring to FIG. 2A, according to some embodiments, in operation S110 of obtaining a first OPCed design layout of the OPC method, a design layout of a target pattern to be formed on a substrate, that is, an OPC target design layout OPC-TG may be provided (e.g., input). The OPC target design layout OPC-TG may have, for example, a right-angled design layout. The right-angled design layout may refer to a layout in which edges are formed by only straight lines. For example, as shown in FIG. 2A, the OPC target design layout OPC-TG may have a rectangular shape extending in a horizontal direction. However, the shape of the OPC target design layout OPC-TG is not limited to a rectangular shape.

Referring to FIG. 2B, thereafter, edges of the OPC target design layout OPC-TG may be divided into a plurality of segments Sg (referred to as forward segments Sg) according to a predetermined dividing rule. The dividing rule may include positions of dissection points DP (referred to as forward dissection points DP), lengths of the segments Sg (the forward segments Sg), or the like. The segments Sg generated by (or before the application of) the first OPC on the OPC target design layout may be referred to as forward segments Sg. The segments Sg generated by (during) the second OPC (e.g., by the reverse dissection) on the OPC target design layout (e.g., an internal OPC target design layout iOPC-TG, which will be described below) may be referred to as reverse segments Sg. Dissection points DP generated by (or before the application of) the first OPC on the OPC target design layout may be referred to as forward dissection points DP. Dissection points DP generated by (or during) the second OPC on the OPC target design layout (e.g., an internal OPC target design layout iOPC-TG, which will be described below) may be referred to as reverse dissection points DP. In some embodiments, the forward and reverse segments Sg may refer to a portion of the OPC target design layout OPC-TG (e.g., internal OPC target design layout iOPC-TG) between the (adjacent) forward and reverse dissection points DP, respectively.

Referring to FIG. 2C, after dividing the OPC target design layout OPC-TG into segments Sg (the forward segments), a first OPC may be performed on the OPC target design layout OPC-TG to generate a first OPCed design layout OPC-OP. In brief, the first OPC (for example, a basic OPC or a commercial OPC) may be performed by inputting data about the OPC target design layout OPC-TG into an OPC model, and extracting a simulation contour through simulation. For reference, various pieces of basic data may be entered as input data into the OPC model. The basic data may include data about the OPC target design layout OPC-TG (e.g., the forward dissection points DP and/or the forward segments Sg). In addition, the basic data may include information data such as the thickness, refractive index, and dielectric constant of a photoresist (PR) material, source map data about the type of an illumination system, or the like. However, the basic data is not limited thereto. The simulation contour may be a result of simulation performed using the OPC model and may correspond to the shape of the target pattern that is to be formed on a wafer through an exposure process using a mask. The first OPC (e.g., a basic OPC or a commercial OPC) may be performed to make the simulation contour as similar as possible to the shape of the target pattern.

In general, the shape of the simulation contour (initial simulation contour) may deviate significantly from the shape of the target pattern. Therefore, to reduce (e.g., to minimize) the difference between the simulation contour and the shape of the target pattern, the simulation contour and the target pattern may be compared with each other, and the positions of segments (the positions of the forward segments Sg) of the OPC target design layout OPC-TG may be changed (along with the change of the positions of the forward dissection points DP) to generate a new OPC design layout. Thereafter, data about the new OPC design layout may be input into the OPC model, and a new simulation contour may be extracted again through simulation. These procedures may be repeated until set conditions are satisfied. For example, conditions may be set based on an edge placement edge (EPE) value or the number of repetitions. That is, the operation of extracting a simulation contour may be repeated until the EPE value is less than or equal to a set reference value or until the number of repetitions reaches a set reference number. The term “EPE” may refer to a difference between a simulation contour and a target pattern at an evaluation point. In addition, the reference number may be set based on the average number of times of simulation or the maximum number of times of simulation until the EPE reaches the reference value through simulation using the OPC model. In the end, an OPC design layout finally generated through this iterative operation may correspond to an OPCed design layout, that is, a first OPCed design layout OPC-OP obtained by the OPC method according to some embodiments.

FIGS. 3A, 3B, and 3C are conceptual views illustrating the concept of bias consistency in a full chip FC. FIG. 3A illustrates the shape of the full chip FC, FIG. 3B illustrates patterns RP included in the full chip FC, and FIG. 3C illustrates first OPCed design layouts (e.g., the first OPCed design layout OPC-OP) and biases for patterns RP at positions \textcircled{1}, \textcircled{2}, \textcircled{3}, and \textcircled{4} of the full chip FC.

Referring to FIGS. 3A, 3B, and 3C, the patterns RP included in the full chip FC may have the same shape and may be regularly repeated as shown in FIG. 3B. Therefore, the patterns RP at positions \textcircled{1}, \textcircled{2}, \textcircled{3}, and \textcircled{4} may all have the same shape and the same surroundings. Therefore, in principle (or in theory), all segments (e.g., the forward segments Sg) that are at the same (corresponding) points in the patterns RP at positions \textcircled{1}, \textcircled{2}, \textcircled{3}, and \textcircled{4} should have the same bias. However, as shown in FIG. 3C, in the first OPCed design layouts (e.g., the first OPCed design layout OPC-OP), segments (e.g., the forward segments Sg) at the same (corresponding) lower points may all have different biases at positions \textcircled{1}, \textcircled{2}, \textcircled{3}, and \textcircled{4}. For example, a lower segment of the pattern RP at position \textcircled{1} may have a bias of 2.65, a lower segment of the pattern RP at position \textcircled{2} may have a bias of 2.55, a lower segment of the pattern RP at position \textcircled{3} may have a bias of 2.60, and a lower segment of the pattern RP at position \textcircled{4} may have a bias of 2.75. As in bias allocation operations shown in FIGS. 6A, 6B, 6C, 6D, and 6E, the term “bias” may refer to a distance by which a segment (e.g., the forward segment Sg) of an OPC target design layout (e.g., the OPC target design layout OPC-TG) is to be moved, and may be defined as a difference between corresponding segments (portions) of an OPC target design layout (e.g., the OPC target design layout OPC-TG) and a first OPCed design layout (e.g., the first OPCed design layout OPC-OP) generated based on the OPC target design layout.

As described above, a situation, in which segments (portions corresponding to the forward segments Sg) having the same surroundings in a first OPCed design layout of a full chip have different biases, may be referred to as a full-chip consistency issue. In general, additional correction operations may be performed later to address the full-chip consistency issue. The full-chip consistency issue will now be further described. Various techniques have been applied to improve mask quality, and one of such techniques is to improve (e.g., maintain) mask consistency. In general, simulations for OPC are performed by setting a grid of an OPC model to satisfy both runtime and OPC consistency. However, due to a grid dependency issue of OPC models, consistency differences may occur depending on positions, and thus mask quality may deteriorate. Various techniques such as a cell OPC technique have been applied to overcome consistency differences. However, due to runtime and technical issues, such technologies are still only for improving (e.g., maintaining) consistency in a selected region rather than improving (e.g., maintaining) consistency in the entire area. Therefore, mask quality deterioration may still occur due to the full-chip consistency issue.

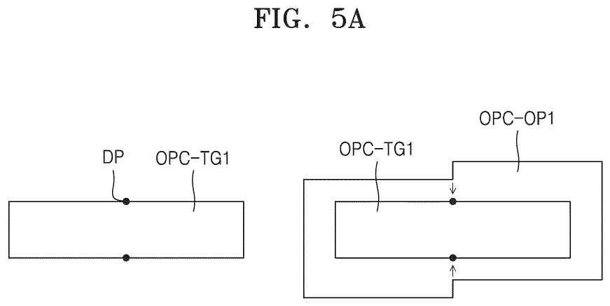

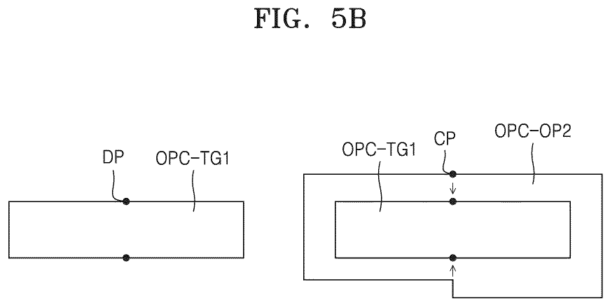

FIGS. 4A and 4B are conceptual views illustrating operation 120 of performing a reverse dissection in the OPC method shown in FIG. 1. FIGS. 5A and 5B are conceptual views illustrating an unusual case in an operation of generating dissection points as shown in shown in FIG. 4B. Descriptions given with reference to FIG. 1 may be briefly given here or omitted.

Referring to FIG. 4A, according to some embodiments, in operation S120 of performing a reverse dissection in the OPC method, first, an OPC target design layout OPC-TG may be superposed on a first OPCed design layout OPC-OP. In some embodiments, the first OPCed design layout OPC-OP may be generated by the first OPC based on the OPC target design layout OPC-TG. As shown in FIG. 4B, in general, edges of the OPC target design layout OPC-TG (e.g., an internal OPC target design layout iOPC-TG, which will be described below) may be positioned inside the first OPCed design layout OPC-OP. In addition, the positions of vertices of the OPC target design layout OPC-TG, for example, the positions of the four vertices of a rectangle, may remain substantially unchanged. For example, the first OPCed design layout OPC-OP may have vertices that are disposed at substantially the same positions as the corresponding vertices of the OPC target design layout OPC-TG. Therefore, the OPC target design layout OPC-TG may be superposed on the first OPCed design layout OPC-OP based on the vertices of the OPC target design layout OPC-TG. Here, the vertices may each refer to a point at which adjacent straight edges meet each other.

Referring to FIG. 4B, thereafter, the vertices of the first OPCed design layout OPC-OP may be projected onto the OPC target design layout OPC-TG (e.g., an internal OPC target design layout iOPC-TG, which will be described below). This projection may generate a plurality of dissection points DP (the reverse dissection points DP) on the edges of the OPC target design layout OPC-TG. The dissection points DP (the reverse dissection points DP) generated by the vertices of the first OPCed design layout OPC-OP projected onto the OPC target design layout OPC-TG may be substantially the same as the dissection points DP (the forward dissection points DP) that divide the edges of the OPC target design layout OPC-TG into segments Sg (the forward segments Sg) in the first OPC. Ultimately, operation S120 of performing a reverse dissection may correspond to an operation of reversely finding dissection points DP (the forward segments Sg) used when dividing edges of the OPC target design layout OPC-TG into segments Sg (the forward segments Sg) in the first OPC.

When dissection points DP (the reverse dissection points DP) are generated in (on) the OPC target design layout OPC-TG (e.g., an internal OPC target design layout iOPC-TG, which will be described below) through operation S120 of performing a reverse dissection, segments Sg (the reverse segments Sg) may be defined by the dissection points DP (the reverse dissection points DP). That is, a straight edge portion of the OPC target design layout OPC-TG between the adjacent dissection points DP (adjacent reverse dissection points DP) may correspond to a segment Sg (the reverse segment Sg). In some embodiments, the reverse segment Sg may be (substantially) the same as the corresponding forward segment Sg.

In some embodiments, the first OPCed design layout OPC-OP may not include vertices corresponding to dissection points DP (the forward dissection points DP) of the OPC target design layout OPC-TG. For example, points corresponding to the vertices of the first OPCed design layout OPC-OP may exist as collinear points on edges of the first OPCed design layout OPC-OP. In this case, dissection points DP (the reverse dissection points DP) corresponding to the vertices of the first OPCed design layout OPC-OP may not be generated by projecting vertices. For example, referring to FIG. 4B, in a horizontal center portion of the first OPCed design layout OPC-OP, upper and lower long straight edges do not have vertices, and thus, dissection points (e.g., the reverse dissection points DP) corresponding to vertices may not be generated. As a result, some of the forward dissection points DP may not correspond to the reverse dissection points DP.

As described above, when it is impossible to generate some of the dissection points (some of the reverse dissection points DP corresponding to the forward dissection points DP) by projecting vertices, dissection points may be generated through calculation as described below with reference to FIGS. 5A and 5B.

Referring to FIGS. 5A and 5B, when a first OPCed design layout OPC-OP1 is obtained by performing a first OPC on an OPC target design layout OPC-TG1 as shown in FIG. 5A, all dissection points DP (forward dissection points DP) may be disposed at vertices on edges of the first OPCed design layout OPC-OP1. Therefore, all dissection points DP (reverse dissection points DP) may be generated on the OPC target design layout OPC-TG1 (e.g., an internal OPC target design layout iOPC-TG, which will be described below) by projecting vertices of the first OPCed design layout OPC-OP1.

However, when a first OPCed design layout OPC-OP2 is obtained by performing a first OPC on an OPC target design layout OPC-TG1 as shown in FIG. 5B, some of dissection points DP (some of forward dissection points DP) may not be disposed at vertices on edges of the first OPCed design layout OPC-OP2. That is, a point corresponding to an upper dissection point DP (an upper forward dissection point DP) may exist as a collinear point CP on an upper straight edge of the first OPCed design layout OPC-OP2. Therefore, the dissection point DP (the reverse dissection point DP) corresponding to the collinear point CP may not be generated on the OPC target design layout OPC-TG1 (e.g., an internal OPC target design layout iOPC-TG, which will be described below) by projecting a vertex.

In general, a minimum segment length and a maximum segment length are set in a dividing rule that is used for defining segments. For example, the second OPC may include a dividing rule for a minimum segment length and a maximum segment length of the first OPCed design layout (e.g., the first OPCed design layout OPC-OP2). Therefore, a dissection point (a reverse dissection point DP) corresponding to a collinear point CP may be generated through calculation using a minimum segment and a maximum segment. For example, when a segment length is set to range from 1 to less than 2 and the first OPCed design layout OPC-OP2 has a straight edge having a length of 2, a middle point at which the straight edge is divided into two equal parts, that is, parts each having a length of 1, may correspond to a collinear point CP, and a corresponding dissection point DP (the corresponding reverse dissection point DP) may be generated by projecting the collinear point CP. When the first OPCed design layout OPC-OP2 has a straight edge having a length of 3, the straight edge may be divided into three equal parts, that is, parts each having a length of 1, and two colinear points CP and two dissection points DP (two reverse dissection points DP) corresponding to the two collinear points CP may be generated. When the first OPCed design layout OPC-OP2 has a straight edge having a length of 2.4, the straight edge may be divided into two equal parts, that is, parts each having a length of 1.2, and one colinear point CP and one dissection point DP (one reverse dissection point DP) corresponding to the collinear point CP may be generated.

FIGS. 6A, 6B, 6C, 6D, and 6E are conceptual views illustrating operation S130 of performing a reverse correction in the OPC method shown in FIG. 1. Descriptions given with reference to FIG. 1 may be briefly given here or omitted.

Referring to FIG. 6A, according to some embodiments, in operation S130 of performing a reverse correction in the OPC method, first, a query box QB may be generated for each of segments Sg (reverse segments Sg) defined by dissection points DP (reverse dissection points DP). As indicated by a dashed rectangle in FIG. 6A, the query box QB may have a rectangular shape including a corresponding segment, that is, a first segment Sg_A. The query box QB may be generated based on a set maximum correction value Mco. In addition, the maximum correction value Mco may be identical in upward and downward directions with respect to the first segment Sg_A. In some embodiments, the first segment Sg_A may be a portion of the reverse segments Sg.

As shown in FIG. 6A, the query box QB may include at least a portion of adjacent patterns (of the first OPCed design layout OPC-OP). In some embodiments, however, the query box QB may include only a pattern corresponding to the first segment Sg_A (of the first OPCed design layout OPC-OP). That is, whether the query box QB includes a portion of adjacent patterns (of the first OPCed design layout OPC-OP) may be determined depend on the set maximum correction value Mco. In addition, hereinafter, a design layout (the OPC target design layout OPC-TG) in which (on which) dissection points DP (reverse dissection points DP) and segments Sg (reverse segments Sg) are generated may be referred to as an internalized OPC target design layout iOPC-TG.

Referring to FIG. 6B, after generating the query box QB, all biases included in the query box QB may be extracted. As described above, the term “bias” refers to a difference or distance between a segment (a portion) of the first OPCed design layout OPC-OP and a segment (reverse segment Sg) of the internalized OPC target design layout iOPC-TG corresponding to the portion, and thus, biases may correspond to edge portions of the first OPCed design layout OPC-OP included in the query box QB. In FIG. 6B, the extracted biases and the first segment Sg_A are indicated by thick solid lines. In addition, FIG. 6B and FIGS. 6C, 6D, and 6E below show only corresponding portions inside the query box QB without showing the query box QB.

Referring to FIG. 6C, after extracting all the biases included in the query box QB, all vertical biases perpendicular to the first segment Sg_A may be removed. That is, as indicated by thick solid lines in FIG. 6C, only horizontal biases extending in a horizontal direction may remain after the vertical biases are removed.

Referring to FIG. 6D, thereafter, the directions of the first segment Sg_A and the remaining biases may be set. The directions of the first segment Sg_A and the remaining biases may be set to be clockwise or counterclockwise with respect to edges of the entire pattern. According to some embodiments, the OPC method may set the directions of the first segment Sg_A and the remaining biases to be clockwise. Therefore, the direction of a segment (e.g., the first segment Sg_A) or bias on an upper side of the pattern may be rightward, and the direction of a segment or bias on a lower side of the pattern may be leftward. For reference, the term “pattern” refers to a concept indicating the form of a layout and may encompass both the first OPCed design layout OPC-OP and the internalized OPC target design layout iOPC-TG.

After setting the directions of the first segment Sg_A and the remaining biases, all biases having directions different from the direction of the first segment Sg_A may be removed. That is, as indicated by thick arrows in FIG. 6D, all leftward biases indicated by X may be removed. Therefore, after some biases are removed according to the directions of biases, only two rightward biases may remain.

Referring to FIG. 6E, a bias Bs closest to the first segment Sg_A may be selected. For example, when one bias remains through the operations described with reference to FIGS. 6A to 6D, the remaining bias may be allocated as a bias of the first segment Sg_A. However, when a plurality of biases remains after the operations described with reference to FIGS. 6A to 6D, one of the biases that is closest to the first segment Sg_A may be selected, and the selected bias may be allocated as a bias of the first segment Sg_A. For example, as indicated by thick arrows in FIG. 6E, a bias of another pattern portion indicated by X among two biases may be removed. Therefore, a bias adjacent to the first segment Sg_A may be selected and allocated as a bias Bs of the first segment Sg_A.

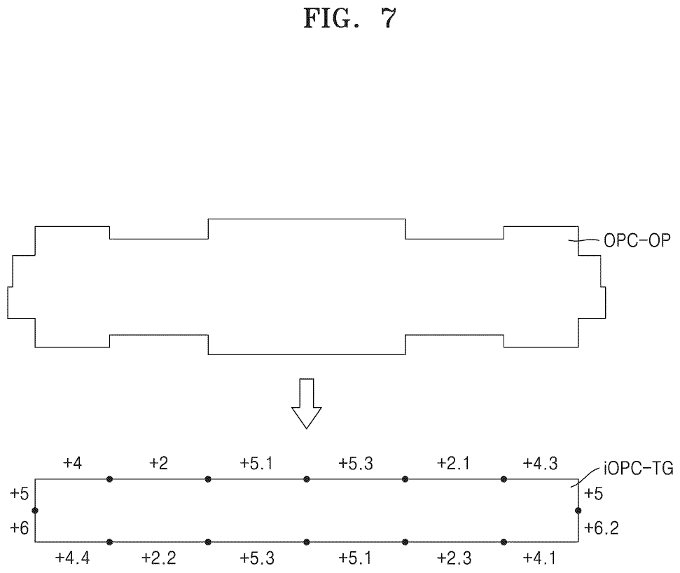

FIG. 7 is a conceptual view illustrating an internalized OPC target design layout iOPC-TG generated after performing a reverse correction according to the OPC method described with reference to FIG. 1. Descriptions given with reference to FIGS. 1 to 6E may be briefly given here or omitted.

Referring to FIG. 7, after performing a reverse correction, biases may be respectively allocated to segments (reverse segments Sg) of the internalized OPC target design layout iOPC-TG. For example, in FIG. 7, an upper pattern may be a first OPCed design layout OPC-OP, and a lower pattern may correspond to a (final) internalized OPC target design layout iOPC-TG generated by performing a reverse dissection and a reverse correction on the first OPCed design layout OPC-OP.

FIGS. 8A, 8B, and 8C are a flowchart and conceptual views illustrating operations of calculating a full-chip representative bias in the OPC method described with reference to FIG. 1.

Referring to FIGS. 8A and 8B, according to some embodiments, in operation S140 of calculating a full-chip representative bias in the OPC method, first, identical segments (e.g., identical reverse segments Sg) may be grouped (operation S142). The identical segments may refer to segments having the same surroundings in patterns having the same shape. For example, in FIG. 8B, four patterns having the same shape may be repeatedly arranged. Therefore, segments of each of the four patterns may have the same surroundings. For example, segments Sg_a of the four patterns may be identical to each other. Similarly, segments Sg_b of the four patterns may be identical to each other, and segments Sg_c of the four patterns may also be identical to each other. Therefore, the segments Sg_a of the four patterns may be grouped as a group, the segments Sg_b of the four patterns may be grouped as another group, and the segments Sg_c of the four patterns may be grouped as another group.

In addition, biases of segments included in the same group may be different from each other because of a consistency issue after a first OPC, that is, after a basic OPC or a commercial OPC. For example, the segments Sg_a of the four patterns belonging to the first group may have bias values of A1, A2, A3, and A4 that are different from each other. In addition, the segments Sg_b of the four patterns may have different bias values (e.g., B1, B2, B3, and B4), and the segments Sg_c of the four patterns may have different bias values (e.g., C1, C2, C3, and C4).

Referring to FIGS. 8A and 8C, after grouping the segments (e.g., the segments Sg_a, Sg_b, and Sg_c), a patch representative bias may be calculated for identical groups of each patch (operation S144). As described above, when a full chip is divided in a checkered pattern form, the term “patch” may refer to a small tetragonal portion including checkered patterns. In general, thousands or more repetitive patterns may be on a full chip. In addition, although the number of patterns varies according to the number of patches, several tens to several hundreds of repetitive patterns may be arranged in each patch. Therefore, for ease of calculation, a patch representative bias may be calculated for each patch before a full-chip representative bias is calculated for a full chip.

As shown in FIG. 8C, a representative bias for segments Sg_a of a plurality of patterns within a patch may be calculated, a representative bias for segments Sg_b of the plurality of patterns within the patch may be calculated, and a representative bias may be calculated for segments Sg_c of the plurality of patterns within the patch. According to some embodiments, in the OPC method, a patch representative bias for each patch may be obtained by averaging biases. Therefore, an average value A may be calculated as the representative bias for the segments Sg_a, an average value B may be calculated as the representative bias for the segments Sg_b, and an average value C may be calculated as the representative bias for the segments Sg_c. The patch representative bias may be calculated by a representative bias of the corresponding biases of identical groups (e.g., the representative bias for the segments Sg_a, the representative bias for the segments Sg_b, or the representative bias for the segments Sg_c) within the patch.

In addition, methods of obtaining a patch representative bias for each patch are not limited to the averaging method. For example, the patch representative bias for each patch may be obtained using a minimum value, a maximum value, a priority value, or the like. The method of using a minimum value may be a method of setting the minimum value among all biases as a representative bias, and the method of using a maximum value may be the opposite of the method of using a minimum value. In addition, the method of using a priority value may be a method of allocating a specific priority value to each segment and setting the priority value as a representative bias.

After calculating the patch representative bias for each patch, the full-chip representative bias may be calculated for identical groups in an entire chip area (operation S146). Because the patch representative bias for each patch is calculated, the full-chip representative bias may be easily calculated using the patch representative bias for each patch. The full-chip representative bias may also be calculated using, for example, an average bias value, a minimum bias value, a maximum bias value, and/or a priority value. In addition, biases used for calculating the full-chip representative bias may be patch representative biases that are previously calculated for respective patches.

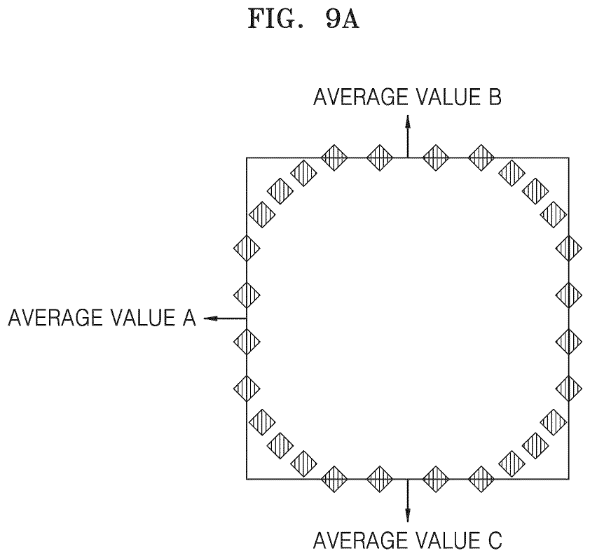

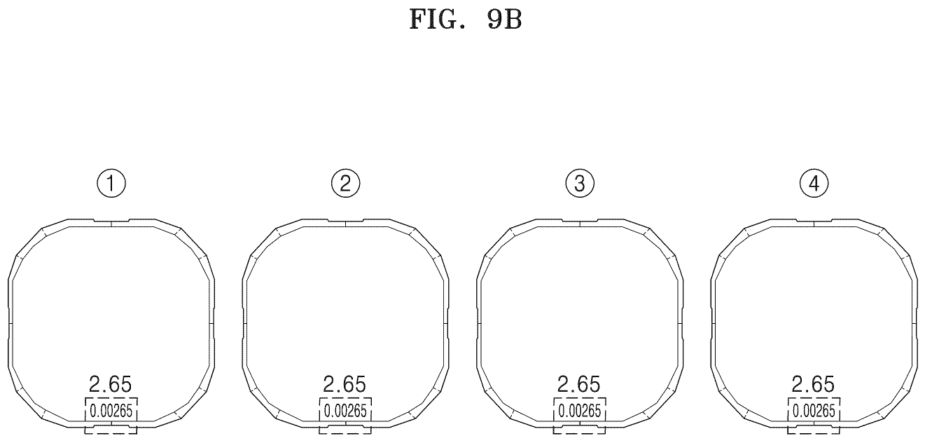

FIGS. 9A and 9B are conceptual views illustrating operation S150 of applying a full-chip representative bias to an entire chip area in the OPC method described with reference to FIG. 1. Descriptions given with reference to FIGS. 1 to 8C may be briefly given here or omitted.

Referring to FIG. 9A, according to some embodiments, in operation S150 of applying a full-chip representative bias to the entire chip area in the OPC method, the full-chip representative bias that is previously calculated may be applied to segments of patterns in the entire chip area. For example, as shown in FIG. 9A, an average value A may be applied to segments Sg_a of the patterns, an average value B may be applied to segments Sg_b of the patterns, and an average value C may be applied to segments Sg_c of the patterns. The average value A, the average value B, and the average value C may each correspond to a full-chip representative bias of corresponding segments.

FIG. 9B illustrates results obtained by applying the full-chip representative bias to the full chip FC shown in FIG. 3A according to the OPC method. That is, FIG. 9B illustrates results of a second OPCed design layout. As shown in FIG. 9B, in the results of the second OPCed design layout, lower segments of the patterns located at positions \textcircled{1}, \textcircled{2}, \textcircled{3}, and \textcircled{4} of the full chip FC may all have the same bias of 2.65. Therefore, it could be understood that the full-chip consistency issue may be addressed through the OPC method according to some embodiments of the present disclosures.

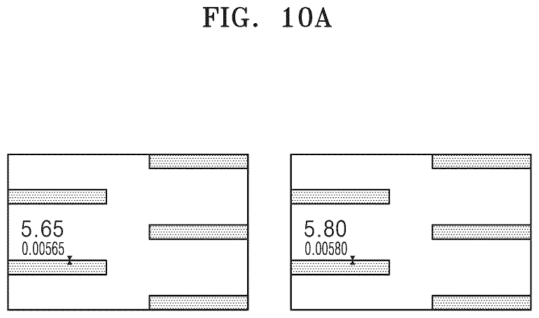

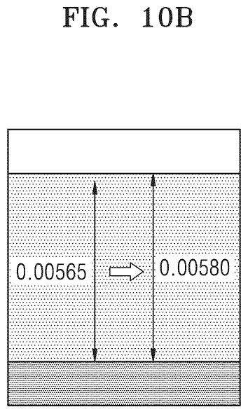

FIGS. 10A and 10B are conceptual views illustrating results of an actual application of the OPC method described with reference to FIG. 1. Descriptions given with reference to FIGS. 1 to 9B may be briefly given here or omitted.

FIG. 10A illustrates two patches each including a plurality of patterns, and the patterns in the two patches have the same shapes and the same surroundings. Therefore, a segment of a pattern having a bias of 5.65 in the left patch and a segment of a pattern having a bias of 5.80 in the right patch may be included in the same segment group. Results of a first OPCed design layout for all patches including the two patches shown in FIG. 10A may show that the same segment group has a total of eight biases as shown in Table 1 below.

TABLE 1

| Group Number | Biases | Numbers of segments |
|---|---|---|
| 8 | 0.00565 | 12 |
| 8 | 0.00575 | 2 |
| 8 | 0.00580 | 20 |
| 8 | 0.00590 | 3 |
| 8 | 0.00595 | 12 |
| 8 | 0.00600 | 3 |
| 8 | 0.00585 | 2 |
| 8 | 0.00560 | 6 |

FIG. 10B is an enlarged view illustrating a portion on which a bias is indicated in the left patch shown in FIG. 10A, and the bias may be changed from 5.65 to 5.8 by the OPC method according to some embodiments. That is, according to some embodiments, the OPC method may be applied to the segment group such that corresponding segments of patterns of patches may all have a bias of 5.8 that is an average value.

According to some embodiments, based on a first OPCed design layout and dissection information, the OPC method may take biases of the first OPCed design layout, set the average of the biases as a representative bias for segments having the same surroundings, and apply the representative bias to an entire chip area, thereby maintaining full-chip consistency across the entire chip area. In addition, according to some embodiments, the OPC method may be applied to not only Manhattan-type OPC but also freeform OPCs including curvilinear shapes, to maintain full-chip consistency. Furthermore, according to some embodiments, the OPC method may be used to maintain full-chip consistency across an entire chip area by using results of all types of OPCs such as extreme ultraviolet (EUV) OPCs and machine learning OPCs as well as basic OPCs. That is, the OPC method may address all inconsistency issues regardless of OPC tools or types of OPC results.

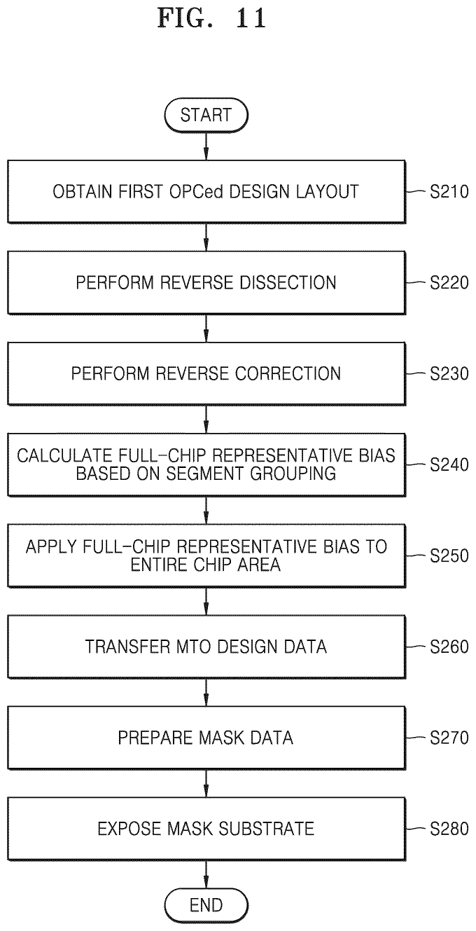

FIG. 11 is a flowchart schematically illustrating operations of a mask manufacturing method including an OPC method according to some embodiments. The following description is given with reference to FIG. 11 and FIG. 1 together, and descriptions given with reference to FIGS. 1 to 10B may be briefly given here or omitted.

Referring to FIG. 11, according to some embodiments, first, the mask manufacturing method including the OPC method (hereinafter simply referred to as the “mask manufacturing method”) may sequentially perform operation S210 of obtaining a first OPCed design layout to operation S250 of applying a full-chip representative bias to an entire chip area. Operation S210 of obtaining a first OPCed design layout to operation S250 of applying a full-chip representative bias to an entire chip area may be substantially the same as operation S110 of obtaining a first OPCed design layout to operation S150 of applying a full-chip representative bias to an entire chip area in the OPC method described with reference to FIG. 1. Therefore, descriptions thereof may be omitted. In addition, as described above, a second OPCed design layout may be obtained by applying the full-chip representative bias to the entire chip area.

After obtaining the second OPCed design layout, mask tape-out (MTO) design data may be prepared (e.g., delivered to a mask production team) (operation S260). In general, preparing the MTO design data may refer to commencing (requesting) mask production by handing over data on a final design layout obtained by an OPC method to a mask production process (or a mask production team). Therefore, according to some embodiments, in the mask manufacturing method, the MTO design data may ultimately refer to the finally (e.g., second) OPCed design layout or data on the finally (e.g., second) OPCed design layout. The MTO design data may have a graphic data format used in electronic design automation (EDA) software or the like. For example, the MTO design data may have a data format such as Graphic Data System II (GDS2) or Open Artwork System Interchange Standard (OASIS).

Afterwards, mask data preparation (MDP) may be performed (operation S270). For example, the MDP may include i) format conversion that is called fracturing, ii) addition (augmentation) of a barcode for mechanical reading, a standard mask pattern for inspection, a job deck, or the like; and iii) automatic and manual verifications. The job deck may refer to generating a text file regarding a series of instructions such as information on the arrangement of multiple mask files, a standard dose, or an exposure speed or method.

The format conversion, that is, fracturing, may refer to a process of preparing the MTO design data in a format for an electron beam exposure machine by fracturing the MTO design data for each region. The fracturing of the MTO design data may include data manipulation such as scaling, data sizing, data rotating, pattern reflecting, or color inverting. In the format conversion through fracturing, data on numerous systematic errors that may occur somewhere during transition from design data to an image on a wafer may be corrected.

The correction of data on systematic errors may be referred to as mask process correction (MPC) and may include line width adjustment that is called critical dimension (CD) adjustment, increasing pattern placement precision, or the like. Therefore, the fracturing may contribute to improving the quality of a final mask and may also be a process that is performed in advance for mask process correction. The systematic errors may be caused by distortions occurring in an exposure process, a mask development process, an etching process, a wafer imaging process, or the like.

In addition, the MDP may include MPC. As described above, MPC refers to a process of correcting errors (that is, systematic errors) that may occur during an exposure process. The exposure process may be an overall concept encompassing electron beam writing, development, etching, baking, and the like. In addition, data processing may be performed prior to the exposure process. The data processing may be a type of preprocessing process for mask data and may include grammar checking for mask data, exposure time prediction, or the like.

After the MDP, a mask substrate may be exposed based on mask data (operation S280). The exposure may refer to, for example, electron beam writing. The electron beam writing may be performed through, for example, a gray writing method using a multi-beam mask writer (MBMW). In addition, the electron beam writing may also be performed using a variable shape beam (VSB) exposure machine.

In addition, after the MDP, a process of converting the mask data into pixel data may be performed before the exposure process. The pixel data may be data directly used in actual exposure, and may include data on shapes to be exposed and data on doses respectively allocated to the shapes. The data on shapes may be bit-map data obtained by converting shape data (vector data) through rasterization or the like.

After the exposure process, a series of processes may be performed to completely manufacture a mask. The series of processes may include, for example, development, etching, and cleaning. In addition, the series of processes for mask manufacturing may include a measurement process, a defect inspection process, or a defect repair process. Furthermore, the series of processes for mask manufacturing may include a pellicle application process. When it is checked that there are no contamination particles or chemical spots on the mask after final cleansing and test processes, the pellicle application process may be performed to attach a pellicle for protecting the mask from follow-up contamination during delivery of the mask and an available lifespan of the mask.

According to some embodiments, in the mask manufacturing method, the OPC method may perform a second OPC on a first OPCed design layout obtained through a first OPC (basic OPC) to obtain a second OPCed design layout, and the second OPCed design layout may improve (e.g., maintain) full-chip consistency. Therefore, according to some embodiments, the mask manufacturing method may be used to manufacture a reliable mask capable of maintaining full-chip consistency.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

The flowcharts and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

According to some embodiments, various operations of the methods described herein may be performed by a processor, processor circuit, circuit, system, device, machine, or the like that includes any combination of firmware, hardware, and/or software that are used in conjunction with memory to store intermediate values and/or results of various operations. For example, obtaining a first optical proximity corrected (OPCed) design layout by implementing a first OPC on an OPC target design layout, performing a reverse dissection on the OPC target design layout based on the first OPCed design layout to generate first segments, performing a reverse correction to allocate first biases of the first OPCed design layout to the first segments of the OPC target design layout, determining a full-chip representative bias based on a segment grouping of the first segments, and/or applying the full-chip representative bias to an entire chip area may be performed by a processor.

While the present disclosures and the inventive concepts thereof have been particularly shown and described with reference to embodiments thereof, it will be understood that various changes in form and details may be made therein without departing from the scope of the following claims.

What is claimed is:

1. A mask manufacturing method comprising:
obtaining a first optical proximity corrected (OPCed) design layout by implementing a first optical proximity correction (OPC) on an OPC target design layout;
performing a reverse dissection on the OPC target design layout based on the first OPCed design layout to generate first segments;
performing a reverse correction to allocate first biases of the first OPCed design layout to the first segments of the OPC target design layout;
determining a full-chip representative bias based on a segment grouping of the first segments;
applying the full-chip representative bias to an entire chip area;
preparing mask data based on the full-chip representative bias that has been applied to the entire chip area; and
exposing a mask substrate based on the mask data.

2. The mask manufacturing method of claim 1, wherein the performing the reverse dissection comprises:
superposing the OPC target design layout on the first OPCed design layout; and
projecting a vertex of the first OPCed design layout onto the OPC target design layout to generate a first dissection point that dissects the OPC target design layout to generate the first segments of the OPC target design layout.

3. The mask manufacturing method of claim 2, wherein the obtaining the first OPCed design layout comprises:
dissecting the OPC target design layout into second segments by a second dissection point;
implementing a first OPC model to the OPC target design layout to generate a simulation contour; and
moving the second segments of the OPC target design layout by comparing the second segments of the OPC target design layout with the simulation contour,
wherein, in the performing of the reverse dissection, when the vertex of the first OPCed design layout corresponds to the second dissection point, the first dissection point is generated at a same position as the second dissection point.

4. The mask manufacturing method of claim 3, wherein, in the performing the reverse dissection, when the vertex of the first OPCed design layout does not correspond to the second dissection point, the first dissection point is generated through a calculation based on a minimum segment length and a maximum segment length of the first OPCed design layout.

5. The mask manufacturing method of claim 1, wherein, in the performing the reverse correction, one of the first biases is determined by a query box that has a maximum bias size.

6. The mask manufacturing method of claim 1, wherein the performing the reverse correction comprises:
generating a query box for the first segments of the OPC target design layout; and
when one of the first segments in the query box comprises an inner segment, allocating one of the first biases in the query box to the inner segment.

7. The mask manufacturing method of claim 6, wherein the allocating one of the first biases in the query box to the inner segment comprises:
removing a perpendicular bias among the first biases in the query box, wherein the perpendicular bias is perpendicular to the inner segment;
removing a different direction bias among the first biases in the query box, wherein the different direction bias is in a direction that is different from a direction of the inner segment; and
when the query box includes a plurality of same direction biases among the first biases in the query box, wherein the plurality of same direction biases are in an identical direction as the inner segment, selecting a closest bias to the inner segment among the plurality of same direction biases.

8. The mask manufacturing method of claim 1, wherein the determining the full-chip representative bias comprises:
performing the segment grouping by grouping the first segments of the OPC target design layout that have identical surroundings into first groups;
determining a patch representative bias for the first groups of each patch; and
determining the full-chip representative bias for the first groups in the entire chip area.

9. The mask manufacturing method of claim 8, wherein the patch representative bias is determined by an average value, a minimum value, a maximum value, and/or a priority value of corresponding biases among the first biases in the first groups of each patch, and
wherein the full-chip representative bias is determined by an average value, a minimum value, a maximum value, and/or a priority value of the corresponding biases among the first biases in the first groups in the entire chip area.

10. The mask manufacturing method of claim 1, wherein a second OPCed design layout is obtained by the applying the full-chip representative bias to the entire chip area, and
wherein in the second OPCed design layout, portions having identical surroundings in the entire chip area have an identical bias.

11. A mask manufacturing method comprising:
obtaining a first optical proximity corrected (OPCed) design layout by implementing a first optical proximity correction (OPC) on an OPC target design layout;
performing a reverse dissection on the OPC target design layout based on the first OPCed design layout to generate first segments;
performing a reverse correction to allocate first biases of the first OPCed design layout to the first segments of the OPC target design layout;
performing a segment grouping by grouping the first segments that have identical surroundings into first groups;
determining a patch representative bias for the first groups of each patch;
determining a full-chip representative bias for the first groups in an entire chip area;
applying the full-chip representative bias to the entire chip area to generate a finally OPCed design layout;
preparing mask data based on the finally OPCed design layout; and
exposing a mask substrate based on the mask data.

12. The mask manufacturing method of claim 11, wherein the performing the reverse dissection comprises:
superposing the OPC target design layout on the first OPCed design layout; and
projecting a vertex of the first OPCed design layout onto the OPC target design layout to generate a first dissection point that dissects the OPC target design layout to generate the first segments.

13. The mask manufacturing method of claim 11, wherein the performing the reverse correction comprises:
generating a query box for the first segments;
when one of the first segments in the query box comprises an inner segment, removing a perpendicular bias among the first biases in the query box, wherein the perpendicular bias is perpendicular to the inner segment;
removing a different direction bias among the first biases in the query box, wherein the different direction bias is in a direction that is different from a direction of the inner segment; and
when the query box includes a plurality of same direction biases among the first biases in the query box and the plurality of same direction biases are in an identical direction as the inner segment, selecting a closest bias to the inner segment among the plurality of same direction biases.

14. The mask manufacturing method of claim 11, wherein the patch representative bias is determined based on an average value, a minimum value, a maximum value, and/or a priority value of corresponding biases among the first biases in the first groups of each patch, and
wherein the full-chip representative bias is determined based on an average value, a minimum value, a maximum value, and/or a priority value of the corresponding biases among the first biases in the first groups in the entire chip area.

15. A mask manufacturing method comprising:
obtaining a first optical proximity corrected (OPCed) design layout by implementing a first optical proximity correction (OPC) on an OPC target design layout;
performing a reverse dissection on the OPC target design layout based on the first OPCed design layout to generate first segments;
performing a reverse correction to allocate first biases of the first OPCed design layout to the first segments of the OPC target design layout;
determining a full-chip representative bias based on a segment grouping of the first segments;
applying the full-chip representative bias to an entire chip area to obtain a finally OPCed design layout;
preparing data on the finally OPCed design layout as mask tape-out (MTO) design data;
preparing mask data based on the MTO design data; and
exposing a mask substrate based on the mask data.

16. The mask manufacturing method of claim 15, wherein the performing the reverse dissection comprises:
superposing the OPC target design layout on the first OPCed design layout; and
projecting a vertex of the first OPCed design layout onto the OPC target design layout to generate a first dissection point that dissects the OPC target design layout to generate the first segments of the OPC target design layout.

17. The mask manufacturing method of claim 15, wherein the performing the reverse correction comprises:
generating a query box for the first segments;
when one of the first segments in the query box comprises an inner segment, removing a perpendicular bias among the first biases in the query box, wherein the perpendicular bias is perpendicular to the inner segment;
removing a different direction bias among the first biases in the query box, wherein the different direction bias is in a direction that is different from a direction of the inner segment; and
when the query box includes a plurality of same direction biases among the first biases in the query box, wherein the plurality of same direction biases are in an identical direction as the inner segment, selecting a closest bias to the inner segment among the plurality of same direction biases.

18. The mask manufacturing method of claim 15, wherein the determining the full-chip representative bias comprises:
performing a segment grouping by grouping the first segments that have identical surroundings into first groups;
determining a patch representative bias for the first groups of each patch; and
determining the full-chip representative bias for the first groups in the entire chip area.

19. The mask manufacturing method of claim 18, wherein the patch representative bias is determined by an average value, a minimum value, a maximum value, and/or a priority value of corresponding biases among the first biases in the first groups of each patch, and
wherein the full-chip representative bias is determined by an average value, a minimum value, a maximum value, and/or a priority value of the corresponding biases among the first biases in the first groups in the entire chip area.

20. The mask manufacturing method of claim 15, wherein the finally OPCed design layout is obtained by the applying the full-chip representative bias to the entire chip area, and
wherein portions of the finally OPCed design layout having identical surroundings in the entire chip area have an identical bias.
